(19) United States
(12) Patent Application Publication
(10) Pub. No.: US 2014/0122046 A1
(43) Pub. Date: May 1, 2014

(54) METHODS AND SYSTEMS FOR EMULATING SPACECRAFT PROXIMITY OPERATIONS IN A LABORATORY

(71) Applicant: HONEYWELL INTERNATIONAL INC., Morristown, NJ (US)

(72) Inventor: Brian Hamilton, Glendale, AZ (US)

(73) Assignee: HONEYWELL INTERNATIONAL INC., Morristown, NJ (US)

(21) Appl. No.: 13/665,172

(22) Filed: Oct. 31, 2012

(51) Int. Cl. G06F 17/00

(52) U.S. Cl. CPC G06F 17/00
USPC 703/8

(57) ABSTRACT

Systems and methods are described for emulating proximity operations of a spacecraft. In one embodiment, a method includes: projecting an image of a first spacecraft on a surface and initiating a proximity operation between the first spacecraft and a second spacecraft. The method further includes evaluating sensor feedback from the second spacecraft based on the proximity operation.

### TECHNICAL FIELD

The present disclosure generally relates to spacecraft proximity operations, and more particularly relates to methods and systems for emulating spacecraft proximity operations in a laboratory.

### BACKGROUND

Laboratories have been developed that enable hardware-in-the-loop simulations of proximity operations performed by spacecraft. For example, the laboratories include a test bed that includes a chaser spacecraft and a target spacecraft simulator that float via air pads on a flat floor. Sensors and actuators of the chaser spacecraft may be tested relative to the target spacecraft. Such a laboratory requires a large space to operate and is expensive to implement.

As a result, it is desirable to provide improved methods and systems for emulating spacecraft proximity operations in a laboratory. Other desirable features and characteristics will become apparent from the subsequent detailed description and the appended claims, taken in conjunction with the accompanying drawings and this background of the invention.

### BRIEF SUMMARY

According to various exemplary embodiments, systems and methods are described for emulating spacecraft proximity operations. In one embodiment, a method includes: projecting an image of a first spacecraft on a surface and initiating a proximity operation between the first spacecraft and a second spacecraft. The method further includes evaluating sensor feedback from the second spacecraft based on the proximity operation.

In another exemplary embodiment, a system includes a projection device that projects an image of a first spacecraft on a surface. The system further includes a hardware prototype of a second spacecraft. The system further includes a test module that initiates a proximity operation between the first spacecraft and the second spacecraft.

Other embodiments, features and details are set forth in additional detail below.

### BRIEF DESCRIPTION OF THE DRAWINGS

The present invention will hereinafter be described in conjunction with the following figures, wherein like numerals denote like elements, and

FIG. 1 is a functional block diagram illustrating a spacecraft emulation system in accordance with exemplary embodiments; and

FIG. 2 is a flowchart illustrating a spacecraft proximity emulation method in accordance with exemplary embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description. As used herein, the term “module” refers to any hardware, software, firmware, electronic control component, processing logic, and/or processor device, individually or in any combination, including, without limitation: an application specific integrated circuit (ASIC), an electronic circuit, a processor (shared, dedicated, or group) and memory that executes one or more software or firmware programs, a combinational logic circuit, and/or other suitable components that provide the described functionality.

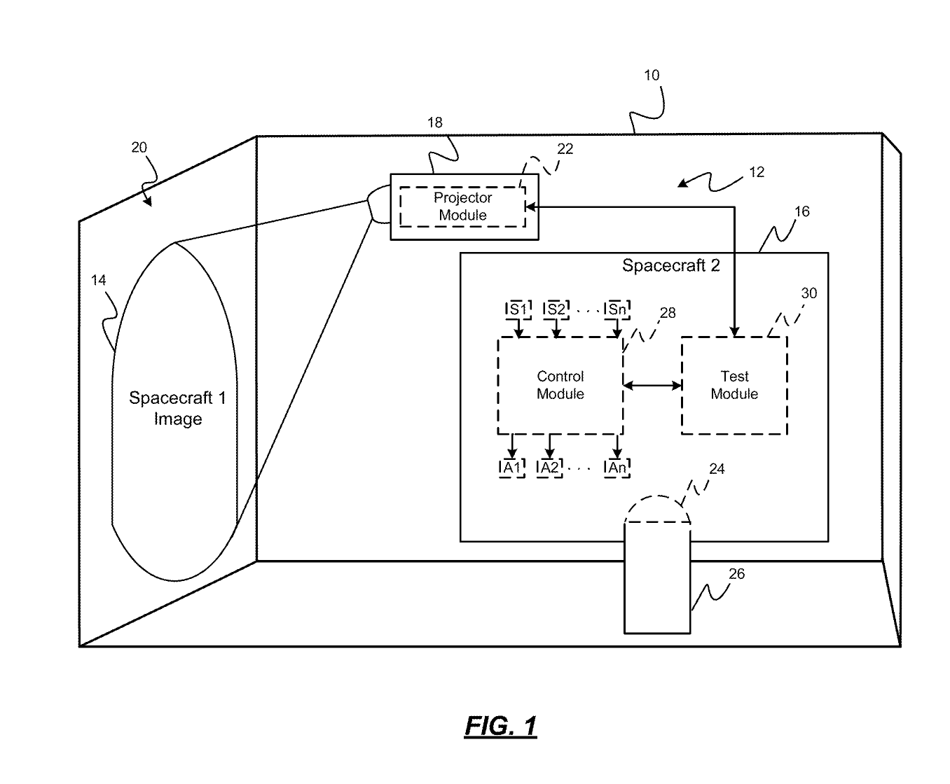

Turning now to the figures and with initial reference to FIG. 1, an exemplary laboratory 10 is shown to include an emulation system shown generally at 12 in accordance with exemplary embodiments. The emulation system 12 emulates and tests proximity operations of spacecraft. The proximity operations can include, but are not limited to, approach, rendevous and docking operations and close maneuvering. Although the figures shown herein depict an example with certain arrangements of elements, additional intervening elements, devices, features, or components may be present in actual embodiments. It should also be understood that FIG. 1 is merely illustrative and may not be drawn to scale.

The exemplary emulation system 12 is shown to include at least two spacecraft 14, 16. The first spacecraft 14 is a projected image of all or part of hardware components of a space vehicle. As can be appreciated, the space vehicle may be any vehicle that is designed to fly in space for example, for the purpose of, communications, earth observation, meteorology, navigation, planetary exploration, and transportation.

In various embodiments, a projector 18 is located in some relation to a surface 20 of the laboratory 10. The projector 18 projects the image of the first spacecraft 14 on the surface 20. The projector 18 includes a projector module 22 that includes or communicates with software such as Satellite Tool Kit (STK) or other software to project the image on the surface 20. The software projects the first spacecraft 14 such that the first spacecraft may be rotated and translated to perform proximity operations.

The second spacecraft 16 is a hardware prototype of a space vehicle. As can be appreciated, the space vehicle may be a hardware prototype of any vehicle that is designed to fly in space, for example, for the purpose of communications, earth observation, meteorology, navigation, planetary exploration, and transportation.

In various embodiments, the second spacecraft 16 is a surrogate spacecraft, or testbed, which can maneuver in three rotational degrees of freedom in the laboratory. As shown, the testbed is supported by a spherical airbearing 24 that may be mounted on a cement or other type of block 26. The testbed is rotatable about xyz axes via the airbearing 24.

The testbed includes any or all of the subsystems that are typically associated with a spacecraft, including but not limited to, attitude control (ACS), a momentum control system (MCS) to torque the vehicle, power, thermal, telemetry and command, structure, and a payload. In general, the testbed includes one or more actuators A1-An, and one or more sensors S1-Sn for managing spacecraft momentum and torque needs for attitude control. The testbed further includes one or more control modules 28 that control the operations of the spacecraft 16 and report a system state. The control module 28 includes embedded software for processing external commands, implementation of control/steering laws and implementation of internal housekeeping, and fault management functions.

The emulation system 12 utilizes the two spacecraft 14, 16 to emulate and test proximity operations, such as, but not limited to docking of the two spacecraft 14, 16. To emulate and test the spacecraft 14, 16, the emulation system 12 includes one or more test modules 30. The test module 30 communicates with the projector module 22, and/or the control module 28. The test module 30 can be located on the second spacecraft 16 (as shown), can be located remote from the second spacecraft 16 (e.g., in another room (not shown) separate from the laboratory 10), or located in part on the second spacecraft 16 and located in part remote from the second spacecraft 16 (e.g., as two or more modules that communicate).

The test module 30 issues commands to the projector 18 and the second spacecraft 16, and evaluates feedback from the second spacecraft 16. The test module 30 emulates and tests the various proximity operations by setting the origin of the second spacecraft 16 as an unmoving reference and evaluating the first spacecraft 14 as it translates and rotates with respect to the second spacecraft 16. By evaluating the two spacecraft 14, and 16 in this manner, the sensors S1-Sn of the second spacecraft 16 are able to sense the same images as in actual proximity operations with an actual first spacecraft.

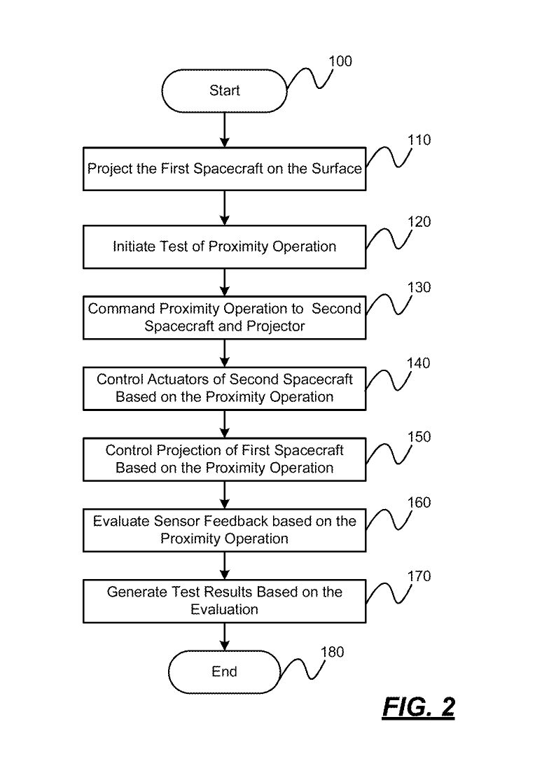

Referring now to FIG. 2, and with continued reference to FIG. 1, a flowchart illustrates an emulation method that can be performed by the emulation system 12 of FIG. 1 in accordance with the present disclosure. As can be appreciated in light of the disclosure, the order of operation within the method is not limited to the sequential execution as illustrated in FIG. 2, but may be performed in one or more varying orders as applicable and in accordance with the present disclosure.

The method may begin at 100. The first spacecraft 14 is projected on the surface 20 of the laboratory 10 at 110. A test of a proximity operation is initiated by the test module 16 at 120. Based on the proximity operation, one or more commands are generated by the test module 30 to the control module 28 of second spacecraft 16 and to the projector module 22 of the projector 18 at 130. The actuators A1-An and/or the sensors S1-Sn of the second spacecraft 16 are controlled by the control module 28 based on the commands at 140. Substantially simultaneously or thereafter, projection of the first spacecraft 14 is controlled by the projector module 22 based on the commands at 150. The test module 30 collects and evaluates feedback from the control module 28 and/or the sensors S1-Sn based on the proximity operation at 160. Test results are then generated based on the evaluation at 170. Thereafter, the method may be repeated and/or may end at 180.

As can be appreciated, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

While at least one example embodiment has been presented in the foregoing detailed description of the invention, it should be appreciated that a vast number of equivalent variations exist. It should also be appreciated that the embodiments described above are only examples, and are not intended to limit the scope, applicability, or configuration of the invention in any way. Rather, the foregoing detailed description will provide those skilled in the art with a convenient road map for implementing various examples of the invention. It should be understood that various changes may be made in the function and arrangement of elements described in an example embodiment without departing from the scope of the invention as set forth in the appended claims and their legal equivalents.

What is claimed is:

1. A method for emulating proximity operations of a spacecraft, comprising:
projecting an image of a first spacecraft onto a surface;
initiating a proximity operation between the first spacecraft and a second spacecraft; and
evaluating sensor feedback from the second spacecraft based on the proximity operation.

2. The method of claim 1, wherein the proximity operation is at least one of an approach, a rendezvous operation, a docking operation, and a close maneuvering.

3. The method of claim 1, further comprising controlling actuators of the second spacecraft based on the proximity operation.

4. The method of claim 1, further comprising controlling the projection of the first spacecraft based on the proximity operation.

5. The method of claim 1, further comprising generating test results based on the evaluating.

6. The method of claim 1, further comprising setting an origin of the second spacecraft as an unmoving reference, and wherein the evaluating comprises evaluating the first spacecraft as it at least one of translates and rotates with respect to the second spacecraft.

7. A system for emulating proximity operations of a spacecraft, comprising:
a projection device that projects an image of a first spacecraft onto a surface;
a hardware prototype of a second spacecraft; and
a test module in operable communication with at least the second spacecraft and that initiates a proximity operation between the first spacecraft and the second spacecraft.

8. The system of claim 7, wherein the proximity operation is at least one of an approach, a rendezvous operation, a docking operation, and a close maneuvering.

9. The system of claim 7, wherein the test module evaluates sensor feedback from the second spacecraft based on the proximity operation.

10. The system of claim 9, wherein the test module generates test results based on the evaluating.

11. The system of claim 7, further comprising a control module of the second spacecraft and wherein the test module communicates with the control module.

12. The system of claim 11, wherein the control module controls actuators of the second spacecraft based on the proximity operation.

13. The system of claim 11, wherein the test module communicates with the projection device.

14. The system of claim 7, wherein the test module is integrated with the second spacecraft.

15. The system of claim 7, wherein the test module is located remotely from the second spacecraft.

16. The system of claim 7, wherein the projection device projects the image of the first spacecraft based on the proximity operation.

17. The system of claim 7, wherein the test module sets an origin of the second spacecraft as an unmoving reference, and evaluates the first spacecraft as it at least one of translates and rotates with respect to the second spacecraft.
